(19) United States
(12) Patent Application Publication
(10) Pub. No.: US 2002/0176173 A1
(43) Pub. Date: Nov. 28, 2002

(54) Wearable display system and process thereof

(76) Inventor: Young-ran Song, Gyeonggi-do (KR)

Correspondence Address: STAAS & HALSEY LLP, 700 11TH STREET, NW, SUITE 500, WASHINGTON, DC, 20001, US

(21) Appl. No.: 10/134,698

(22) Filed: Apr. 30, 2002

(30) Foreign Application Priority Data
Apr. 30, 2001 (KR) 2001-23342
Aug. 25, 2001 (KR) 2001-51585

(51) Int. Cl. G02B 27/14

(52) U.S. Cl. 359/630

(57) ABSTRACT

A wearable display system having at least one display panel to display a signal processed in a predetermined way. The system includes a waveguide to transmit a signal that is incident thereon from the display panel and at least one magnifying lens attached to an end of the waveguide to magnify the signal transmitted via the waveguide, wherein at least one end of the waveguide is diagonally cut at a predetermined angle so that the signal output from the display panel is totally reflected inside the waveguide. The wearable display system is easy to make with a minimum number of optical devices, and therefore it is possible to reduce manufacturing cost and time.

### CROSS-REFERENCE TO RELATED APPLICATIONS

This application claims the benefit of Korean Application Nos. 2001-23342 filed on Apr. 30, 2001 and 2001-51585 filed on Aug. 25, 2001 in the Korean Industrial Property Office, the disclosures of which are incorporated herein by reference.

### BACKGROUND OF THE INVENTION

1. Field of the Invention

The present invention relates to a personal display system, and more particularly, to a wearable display system to display a display signal which is transmitted through a magnifying optical device such as an eyeglass-type or goggle-type optical device, at a location near an eye of a user, and a process thereof.

2. Description of the Related Art

Conventional optical display systems used in the military, medicine or for personal entertainment, which are generally known as head (helmet) mounted display (HMD) systems, have been designed for users to see video signals magnified via an eyeglass-type, goggle-type or helmet-type wearable device. This personal display system allows users to receive video information while moving from place to place.

FIG. 1 shows an example of an HMD. Referring to FIG. 1, the HMD is made of eyeglasses 100 and an image-driving unit 110 that is attached at the center of the eyeglasses 100. Because of the image-driving unit 110, the HMD is bulky, heavy and not elegant. The image-driving unit 110 includes many optical elements and is therefore heavy and large.

FIG. 2 shows the structure of a general HMD. In FIG. 2, the HMD includes an image-driving unit 200, a display panel 210 and an optical system 220. The image-driving unit 200 stores an image signal received from exterior sources such as a personal computer (PC) or video device (not shown), processes the received signal and displays the signal on the display panel 210, which may be a liquid crystal display (LCD) panel. The optical system 220 makes the image signal displayed on the display panel 210 appear as an appropriate virtual image in the eye of a user via an enlargement optical system. The HMD can further include any wearable devices or cables to receive image signals from an external source.

FIG. 3 shows the general structure of the optical system 220 of the general HMD of FIG. 2. A conventional optical system includes a collimating lens 300, an X prism 310, focusing lenses 320, fold mirrors 330 and ocular lenses (or magnifying lenses) 340. The collimating lens 300 collimates and propagates light (an image signal) emitted from the display panel 210. The X prism 310 redirects the light received from the collimating lens 300 in both the right and left directions. The focusing lenses 320 are separately placed on the right and left of the X prism 310 so that collimated light passing through the X prism 310 is focused. The fold mirrors 330 change the direction of incident light so that the light focused by the focusing lenses 320 travels toward the eyes of a user. The ocular lenses (or magnifying lenses) 340 allow small image signals passing through the above-described optical elements to appear in the eyes of the user. At this time, if an image signal transmitted through the ocular lenses 340 has color, lenses to remove chromatic aberration must be used as the ocular lenses 340.

In a general HMD, an optical system employs several optical elements to meet precise design specifications, such as a collimating lens, an X prism, focusing lenses, fold mirrors, ocular lenses and the like, as described above. For this reason, it is difficult to manufacture the general wearable display system because much time and effort are required . Even if the lenses and elements are designed precisely, additional difficulties in aligning the lenses and devices together may occur. In addition, the conventional optical system is bulky and heavy due to the use of a plurality of optical devices, so that it is inconvenient for a person to wear the HMD and it is expensive to manufacture the HMD.

### SUMMARY OF THE INVENTION

Accordingly, it is an object of the present invention to provide a wearable display system that is simple to manufacture using a minimum number of optical devices.

Additional objects and advantages of the invention will be set forth in part in the description which follows and, in part, will be obvious from the description, or may be learned by practice of the invention.

The foregoing and other objects of the present invention are achieved by providing a wearable display system including at least one display panel to display a signal processed in a predetermined way; a waveguide to transmit a signal that is incident thereon from the display panel, the waveguide having first and second ends; and at least one magnifying lens attached to one of the ends of the waveguide to magnify the signal transmitted via the waveguide, wherein at least one of the ends of the waveguide is diagonally cut at a predetermined angle so that the signal displayed by the display panel is totally reflected inside the waveguide.

The foregoing and other objects of the present invention are also achieved by providing a wearable display system including a display panel to display a signal processed in a predetermined way; a waveguide to transmit the signal incident thereon from the display panel, the waveguide having first and second ends; and an optical device attached to a surface of the waveguide, the optical device to magnify the signal transmitted via the waveguide, wherein the first and second ends of the waveguide are diagonally cut at first and second angles, respectively.

The foregoing and other objects of the present invention are also achieved by providing a wearable display system including a display panel to display a signal processed in a predetermined way; a waveguide to transmit the signal incident thereon from the display panel; a prism attached to a first end of the waveguide, the prism to transmit the signal displayed by the display panel into the waveguide at an angle such that the transmitted signal undergoes total internal reflection inside the waveguide; and an optical device to magnify the signal transmitted via the waveguide, wherein a second end of the waveguide, opposite the first end, is cut at a predetermined angle.

The foregoing and other objects of the present invention are also achieved by providing a wearable display system including a display panel to display a signal processed in a predetermined way; a waveguide to transmit the signal incident thereon from the display panel; and a prism attached to a first end of the waveguide to emit the signal transmitted via the waveguide, wherein a second end of the waveguide, upon which the signal is incident from the display panel, is cut at a predetermined angle.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is an exterior view of a head mounted display (HMD);

FIG. 2 is a block diagram of a general HMD;

FIG. 3 is a schematic diagram of the optical system of the general HMD of FIG. 2;

FIGS. 4A and 4B are a front view and an upper side view, respectively, of a wearable display system according to the present invention;

FIG. 5 is a schematic diagram of a wearable display system according to an embodiment of the present invention;

FIG. 6 is a schematic diagram of a wearable display system according to another embodiment of the present invention;

FIG. 7 is a schematic diagram for explaining parameters of a magnifying optical system which are needed in determining the size of a display panel, the size and position of a screen, an eye relief, a field of view (FOV) and the focus and size of a lens;

FIGS. 8A and 8B are schematic diagrams for explaining specifications of a wearable display panel according to the present invention;

FIG. 9 is a schematic diagram of a binocular wearable display system according to an embodiment of the present invention;

FIG. 10 is a schematic diagram of a binocular wearable display system according to another embodiment of the present invention;

FIG. 11 is a schematic diagram of a wearable display system according to another embodiment of the present invention;

FIG. 12 is a schematic diagram of a wearable display system according to another embodiment of the present invention; and

FIG. 13 is a schematic diagram of a wearable display system according to another embodiment of the present invention.

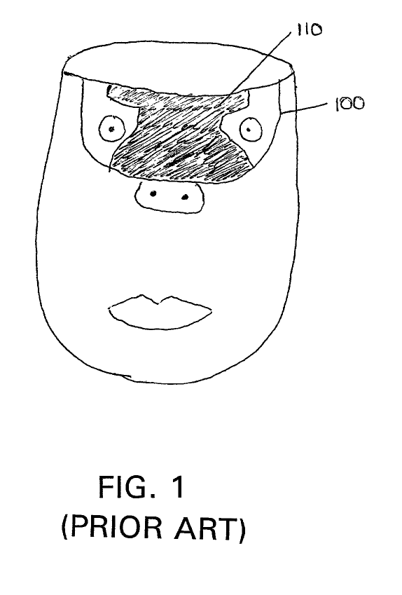

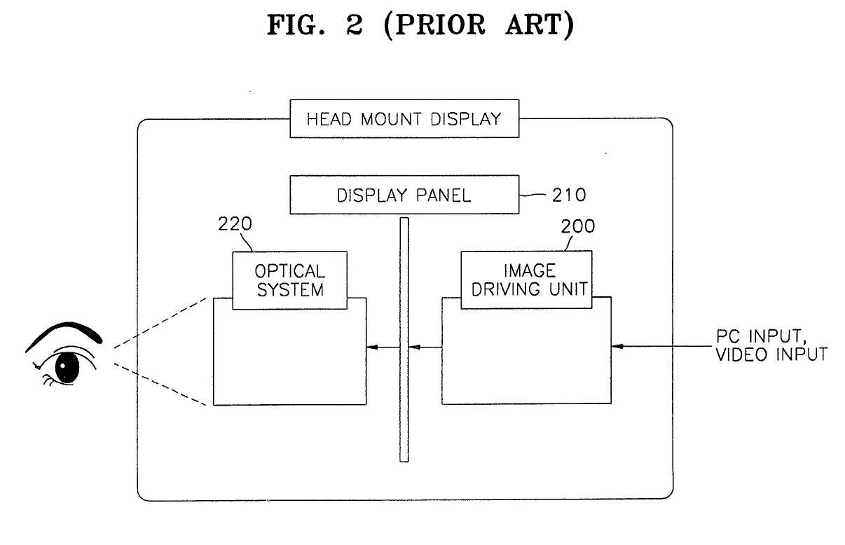

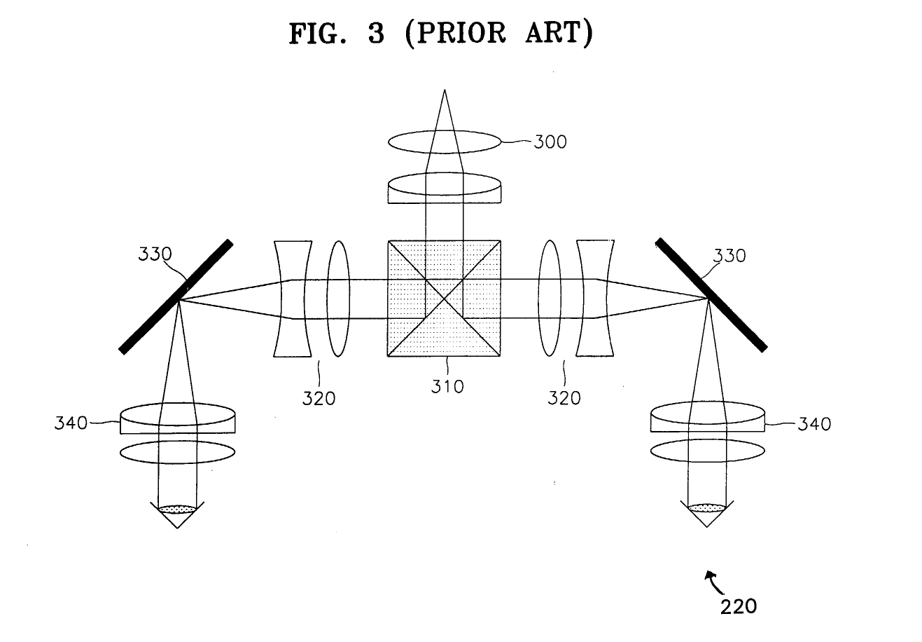

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

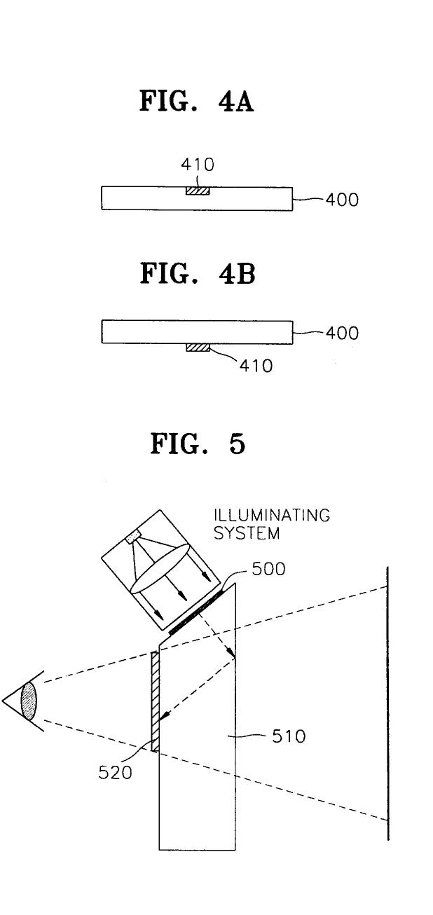

FIGS. 4A and 4B are a front view and an upper side view of a wearable display system according to the present invention, respectively. In FIGS. 4A and 4B, the wearable display system has a simple structure in which a lens 400 and a display panel 410 are combined with each other. The wearable display system of FIGS. 4A and 4B is thinner, lighter and smaller than the conventional designs due to the use of a grating and a magnifying lens. Thus, the wearable display system according to the present invention is easy and convenient to wear, like eyeglasses, unlike existing bulky and heavy helmet-type HMDs. Furthermore, the present invention provides a module-type wearable display system in which a module is capable of being attached to and detached from conventional eyeglasses. The exterior of the wearable display system illustrated in FIGS. 4A and 4B is just an example and a variety of thin, light and small wearable display systems having different exteriors can be realized.

A wearable display system according to the present invention can be manufactured both as a binocular type and a monocular type. A binocular type is designed for a user to look at a display image using both of his or her eyes, whereas a monocular type allows a user to look at a display image using only one of his or her eyes.

First, a monocular-type wearable display system will be described below.

FIG. 5 is a view of a monocular-type wearable display system according to an embodiment of the present invention. The wearable display system includes a display panel 500 which displays a signal processed in a predetermined way, a waveguide 510 and a magnifying lens 520. A signal is incident on the waveguide 510 from the display panel 500, and enters and propagates through the waveguide 510. An end of the waveguide 510, which is positioned in the direction of the transmitted signal, is diagonally cut at the same angle as the total internal reflection angle of the signal so that a signal received from the display panel 500 is perpendicularly incident on the cut end of the waveguide 510 and reflected at an angle of total internal reflection once inside the waveguide 510. The signal which is transmitted from the cut end propagates through the waveguide 510 by being reflected at the total internal reflection angle. The magnifying lens 520 magnifies the signal propagating through the waveguide 510 to be formed as an image in an eye of a user.

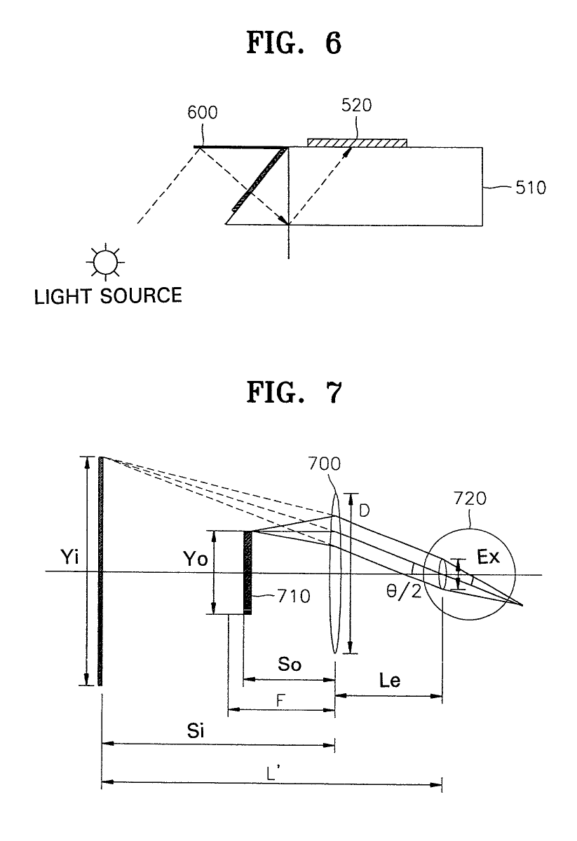

FIG. 6 is a view of a monocular-type wearable display system according to another embodiment of the present invention. Referring to FIG. 6, the wearable display system further includes a reflector 600. With the reflector 600, it is possible to easily control the position of a light source which emits light to be incident on the cut end of the waveguide 510. In the wearable display system shown in FIG. 6, light output from the light source at a corner is reflected from the reflector 600 and is transmitted through the cut end of the waveguide 510 to be incident on the inner side of the waveguide 510 at the total internal reflection angle. If the light source is placed at a same side as a user, it is possible to realize an eyeglass type display system having a light source on the arms of the frame thereof.

To realize the wearable display systems shown in FIGS. 5 and 6, the size of the magnifying lens 520, the number of times a signal undergoes total reflection in the waveguide 510, and the length and width of the waveguide 510 must be determined, according to basic principles of a magnifying optical system.

FIG. 7 is a diagram for explaining parameters of a magnifying optical field which are needed in determining a size of a display panel, a size and location of a screen, an eye relief, a field of view (FOV), a focus and size of a lens, and so on. Referring to FIG. 7, F denotes a focal length of a lens 700 corresponding to the magnifying lens 520 shown in FIG. 5, and D denotes the diameter of the lens 700. Yo denotes the size of an object 710 that corresponds to the display panel 500 shown in FIG. 5. So denotes a distance between the object 710 and the lens 700, which corresponds to the distance between the display panel 500 and the magnifying lens 520. Here, So must be shorter than the focal distance F of the lens 700 so that an image of the object 710 is magnified to the eye of a user. According to this optical principle, the path of a signal which is incident upon and propagates in the waveguide 510, is designed to be shorter than the focal distance of the magnifying lens 520 in FIG. 5. Yi denotes the size of a virtual image of the object 710 to be seen at a position of a user's eye 720 and Ex is the size of an exit pupil of the user's eye 720. Le denotes a distance between the eye of the user 720 and the lens 700, i.e., eye relief, L′ denotes a distance between the user's eye 720 and the virtual image Yi, and θ/2 denotes half of a field of view (FOV) defined below. Si denotes a distance between the virtual image and the lens 700.

Hereinafter, we will explain a process of obtaining parameters of a magnifying lens using the above-described optical parameters. To determine the type of the lens 700 and the position of the object 710 in FIG. 7, the size Yo of the object 710, the size Yi of the virtual image, the distance L′ between the virtual image and the eye of the user 720, the eye relief Le and the exit pupil Ex of the eye of the user 720 must first be determined. Using these optical parameters, a magnification M is obtained by the following expression (1):

$$M = \frac{Y i}{Y o} = \frac{S i}{S o} \qquad ( 1 )$$

The distance So between the lens 700 and the object 710 can be measured by applying the obtained M value to the following expression (2):

$$S o = \frac{S i}{M} \qquad ( 2 )$$

Next, the focal length F of the lens 700 is calculated using So and Si as follows:

$$\frac{1}{S o} - \frac{1}{S i} = \frac{1}{f} \qquad ( 3 )$$

Then, the field of view (FOV) is calculated as follows:

$$F O {V}_{θ} = 2 {tan}^{- 1} \frac{Y i}{2 {L}^{′}} \qquad ( 4 )$$

The diameter D of the lens 700 is measured as follows:

$$tan \frac{θ}{2} = \frac{D}{2 L e} \qquad ( 5 )$$

Expression (5) applies only to a light signal that is incident upon the center of the exit pupil Ex, and therefore, the real diameter D of the lens 700 must be measured as a function of the size of the exit pupil as follows:

$$D = 2 L e tan \frac{θ}{2} + E x \qquad ( 6 )$$

As described above, the particulars of a magnifying lens can be determined using the above expressions.

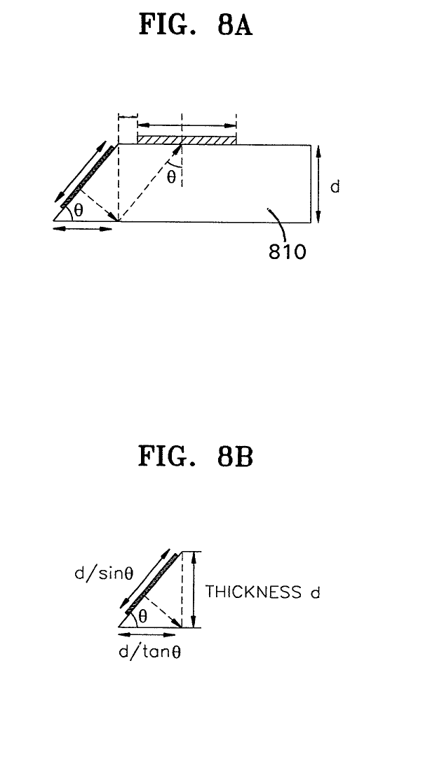

FIGS. 8A and 8B are diagrams for explaining the design specifications of a wearable display system according to an aspect of the present invention. FIG. 8A illustrates a waveguide 810. Referring to FIG. 8B, an angle of incidence θ must be larger than a critical angle of total reflection θ_{c}, and the length d/sinθ of an inclined end of a waveguide must be greater than the length of the display panel. These conditions are expressed as follows:

$$θ > {θ}_{c} = {sin}^{- 1} \frac{1}{n ( w a v e g u i d e )} \qquad ( 7 )$$

wherein n (waveguide) denotes an index of refraction of the waveguide 810. For instance, when the index of refraction of the waveguide 810 is 1.49, the critical angle of total reflection θ_{c} is 42.2 degrees and thus, the angle of incidence θ must be greater than 42.2 degrees.

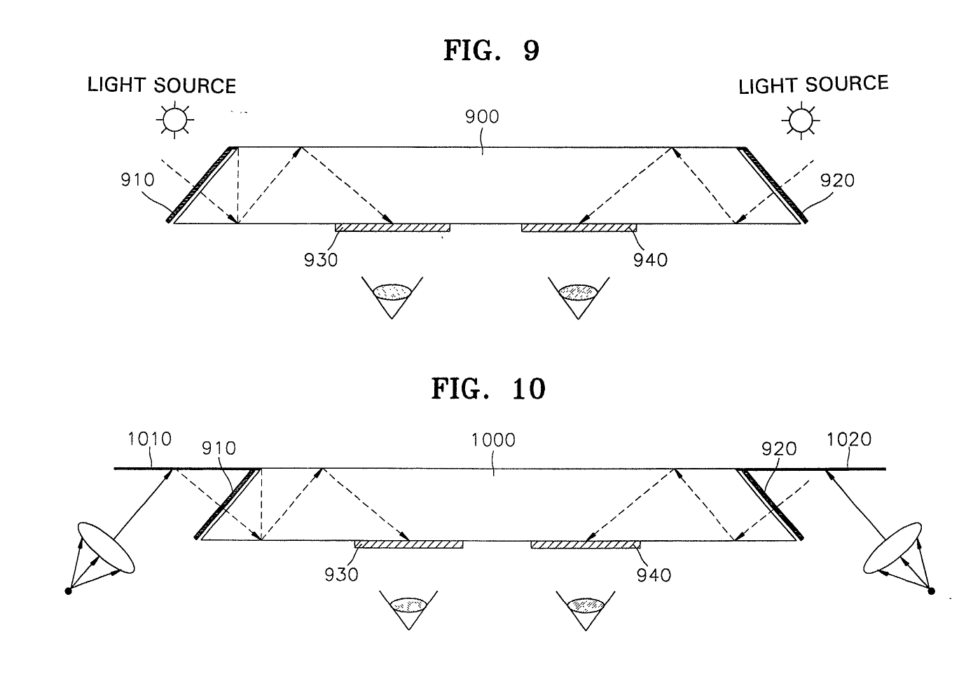

FIG. 9 is a view of a binocular wearable display system according to an embodiment of the present invention. The binocular wearable display system includes a waveguide 900, a first display panel 910, a second display panel 920, a first magnifying lens 930 and a second magnifying lens 940. The principles and specifications of the wearable monocular type display systems described above can be applied to the binocular wearable display system shown in FIG. 9. Furthermore, two monocular-type wearable display systems shown in FIG. 5 can be combined with each other to form a binocular wearable display system such as that shown in FIG. 9. The waveguide 900 receives signals from the first and second display panels 910 and 920, and guides the propagation of the signals. Both ends of the waveguide 900 are diagonally cut to have the same angle as the angle of total internal reflection so that the signals which are transmitted through both ends are reflected at the angle of total internal reflection once inside the waveguide 900. Display signals are perpendicularly incident on the inclined ends of the waveguide 900, reflected at the angle of total internal reflection in the waveguide 900 and propagate towards the center of the waveguide 900. The first display panel 910 is attached to the left inclined end of the waveguide 900 to be incident on the inner wall thereof, and transmits a signal into the waveguide 900 at the angle of total internal reflection. The first magnifying lens 930 magnifies a signal which is reflected more than one time in the waveguide 900 and reaches the first magnifying lens 930, to be seen by the left eye of a user. The second display panel 920 is attached to the right inclined end of the waveguide 900 and transmits a signal into the waveguide 900 at the angle of total reflection. The second magnifying lens 940 magnifies a signal which is reflected more than one time in the waveguide 900, to be seen by the right eye of the user. The first and second magnifying lenses 930 and 940 may be hologram lenses that transmit a signal incident thereon at a predetermined angle (which is the predetermined angle of total internal reflection in this embodiment) in a direction which is consistent with the direction of a pattern on the hologram lens.

FIG. 10 is a view of a binocular wearable display system according to another embodiment of the present invention. The binocular wearable display system shown in FIG. 10 has the same structure and function as the binocular wearable display system shown in FIG. 9, but further includes first and second reflection plates 1010 and 1020. The first and second reflection plates 1010 and 1020 extend from both ends of a waveguide 1000 and reflect light from light sources at predetermined right and left directions of a user toward the inclined ends of the waveguide 1000. In other words, the first and second reflection plates 1010 and 1020 reflect light from light sources placed so that the light is to be incident on the inclined ends of the waveguide 1000 as collimating light. As shown in FIG. 10, since light sources can be placed at either side of the user with the first and second reflection plates 1010 and 1020, it is possible to realize an eyeglass-type wearable display system having light sources at the frame arms.

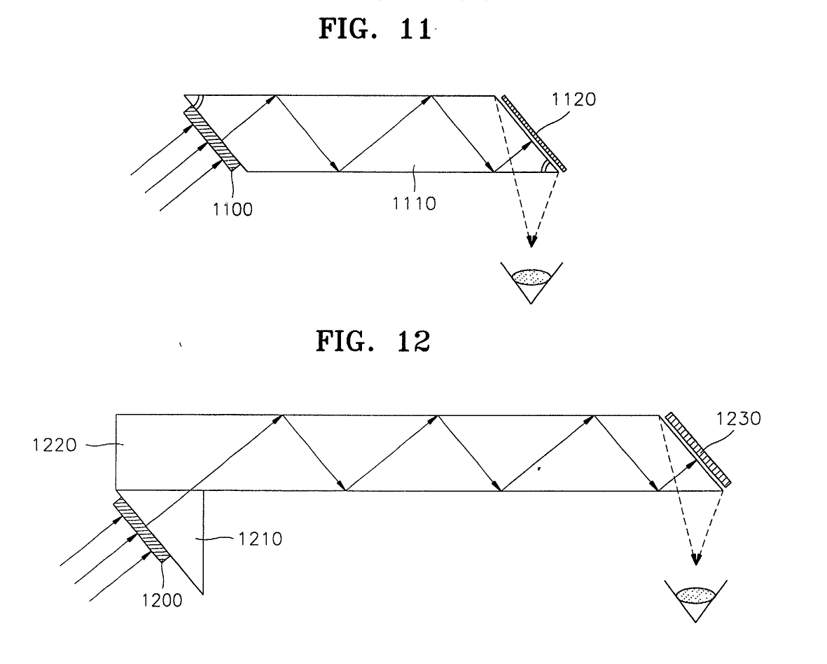

FIG. 11 is a view of a monocular-type wearable display system according to another embodiment of the present invention. The wearable display system includes a display panel 1100 to display a signal processed in a predetermined way, a waveguide 1110 and an optical device 1120.

The waveguide 1110 guides the propagation of a signal incident from the display panel 1100 and has two ends that are diagonally cut at a predetermined angle that reflects an incident signal at the angle of total internal reflection from an inner wall of the waveguide 1110. The signal is incident on one of the ends and is emitted through the other end . The signal is incident on the end which is inclined at the angle of total internal reflection, transmitted into the waveguide 1110 and repeatedly reflected at the angle of total reflection to propagate through the waveguide 1110. The optical device 1120 is a diffractive optical element or a holographic optical element and magnifies the received signal after transmission through the waveguide 1110 to form a magnified image in the eye of the user, who is positioned within a predetermined focal distance. Here, the optical device 1120 is illustrated as a reflection type, but may also be a transmittance type that forms an image of a signal at the opposite side of the waveguide 1110 illustrated in FIG. 11.

When signals emitted from the display panel 1100 propagate through the waveguide 1110 and are output through the optical device 1120, propagation distances of the incident signals may be different from each other, thus generating an aberration. To prevent this aberration, the end of the waveguide 1110 on which the signal is incident must have the same inclination angle as the end of the waveguide 1110 from which the signal is emitted, so that the propagation distances of the incident signals are the same.

The basic principles of the magnifying optical system explained with reference to FIG. 7 are applied in determining the specifications of the waveguide 1110, i.e., the angle of the inclined ends, the number of times a signal propagating therethrough undergoes total internal reflection, the length and width of the waveguide 1110, the diameter of the optical device 1120, the focal length of the optical device 1120 and so on.

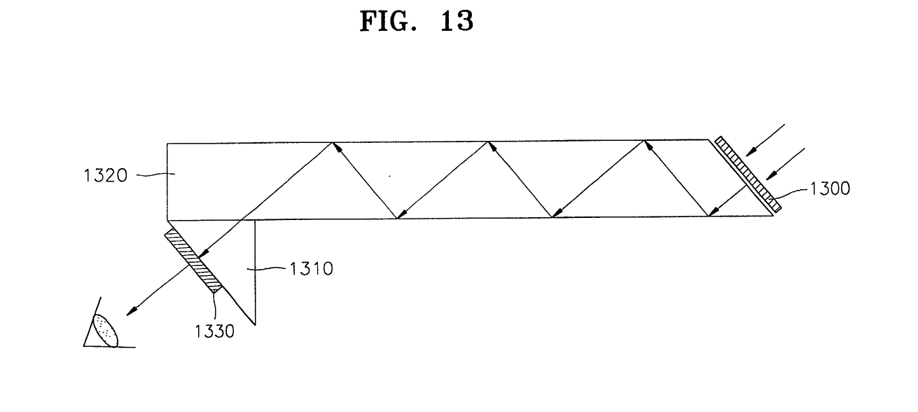

FIG. 12 is a view of a monocular-type wearable display system according to another embodiment of the present invention. The wearable display system includes a display panel 1200 to emit a signal processed in a predetermined way, a prism 1210, a waveguide 1220 and an optical device 1230. The prism 1210 is attached to one side of the waveguide 1220 and has the display panel 1200 on a surface thereof. A signal output from the display panel 1200 is transmitted through the prism 1210 into the waveguide 1220 at a predetermined angle of total internal reflection.

The signal enters the waveguide 1220 via the prism to be repeatedly reflected from the inner surface of the waveguide 1220 at the angle of total internal reflection and propagates through the waveguide 1220. The surface of the waveguide 1220 from which the signal is output is cut at a predetermined angle so that the propagation distance of incident signals through the prism 1210 can be the same, thereby preventing an aberration due to a difference in propagation distance between signals. Here, the inclination angles of both ends of the waveguide 1220 are the same as the incident angle, i.e., the angle of total internal reflection.

The optical device 1230 is a diffractive optical element or a holographic optical element and magnifies a signal that is transmitted via the waveguide 1220 to be formed as an image in the eye of the user. The optical device 1230 is illustrated as a reflection type in FIG. 12, but may be a transmission type that forms an image of a signal at the opposite side of the waveguide 1220, as shown in FIG. 12.

Here, the basic principles of the magnifying optical system are also applied in determining the specifications of the waveguide 1220, i.e., the angle of the inclined ends of the waveguide 1220, the number of times the signal undergoes total internal reflection therein, the length and width of the waveguide 1220, the diameter of the optical device 1230 and the distance at which the signal is focused to form the image.

FIG. 13 is a view of a monocular-type wearable display system according to another embodiment of the present invention. In the wearable display system shown in FIG. 13, a waveguide 1320 has the same structure and elements as the waveguide 1220 shown in FIG. 12. However, the location of a display panel 1300 and the propagation direction of a signal are opposite to those of the wearable display system shown in FIG. 12. The display panel 1300 is attached to the end of the waveguide where the optical device 1230 shown in FIG. 12 is positioned, and a magnifying lens 1330 is attached to the end where the display panel 1200 shown in FIG. 12 is positioned. In FIG. 13, a signal incident on the display panel 1300 is transmitted out of the waveguide 1320 via a prism 1310 and is magnified by the magnifying lens 1330 attached to the prism 1310 to be seen by the eye of the user.

As described above, a wearable display system according to embodiments of the present invention includes a waveguide having an end or ends that are diagonally cut so that a signal can be reflected within the waveguide, thus not requiring any elements to reflect a signal at an angle of total internal reflection. Further, light sources can be freely positioned as desired using a reflection plate.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A wearable display system comprising:
at least one display panel to display a signal;
a waveguide to transmit the signal that is incident thereon from the display panel, the waveguide having first and second ends; and
at least one magnifying lens attached to one of the ends of the waveguide to magnify the signal transmitted via the waveguide,
wherein at least one of the ends of the waveguide is diagonally cut at a predetermined angle so that the signal displayed by the display panel is totally reflected inside the waveguide.

2. The system of claim 1, further comprising at least one reflection plate to reflect the signal displayed by the display panel to the diagonally cut end of the waveguide.

3. A binocular wearable display system comprising:
a plurality of display panels;
a waveguide to transmit a signal emitted from the display panels, the display panels being respectively positioned at first and second ends of the waveguide; and
a plurality of magnifying lenses attached to the waveguide to magnify the signal transmitted via the waveguide,
wherein the first and second ends of the waveguide are diagonally cut at a predetermined angle so that the signal emitted by the display panels is totally reflected in the waveguide.

4. The system of claim 3, further comprising a plurality of reflection plates respectively extending from the first and second ends of the waveguide to reflect the signal emitted by the display panels such that the emitted signal is transmitted into the waveguide through the first and second ends thereof.

5. A wearable display system comprising:
a display panel to display a signal;
a waveguide to transmit the signal incident thereon from the display panel, the waveguide having first and second ends; and
an optical device attached to a surface of the waveguide, the optical device to magnify the signal transmitted via the waveguide,
wherein the first and second ends of the waveguide are diagonally cut at first and second angles, respectively.

6. The system of claim 5, wherein the display panel is attached to the first end of the waveguide and the optical device is attached to the second end of the waveguide.

7. The system of claim 6, wherein the first angle is equal to an angle of total internal reflection of the signal transmitted via the waveguide.

8. The system of claim 7, wherein the second angle is the same as the first angle.

9. The system of claim 5, wherein the optical device is a reflection type optical device.

10. The system of claim 5, wherein the optical device is a transmission type optical device.

11. A wearable display system comprising:
a display panel to display a signal;
a waveguide to transmit the signal incident thereon from the display panel;
a prism attached to a first end of the waveguide, the prism to transmit the signal displayed by the display panel into the waveguide at an angle such that the transmitted signal undergoes total internal reflection inside the waveguide; and
an optical device to magnify the signal transmitted via the waveguide,
wherein a second end of the waveguide, opposite the first end, is cut at a predetermined angle.

12. The system of claim 11, wherein the optical device is a reflection type optical device.

13. The system of claim 11, wherein the optical device is a transmission type optical device.

14. The system of claim 11, wherein the predetermined angle is equal to the angle of total internal reflection.

15. A wearable display system comprising:
a display panel to display a signal;
a waveguide to transmit the signal incident thereon from the display panel; and
a prism attached to a first end of the waveguide to emit the signal transmitted via the waveguide,
wherein a second end of the waveguide, upon which the signal is incident from the display panel, is cut at a predetermined angle.

16. The system of claim 15, wherein the predetermined angle is equal to an angle of total internal reflection of the signal transmitted via the waveguide.

17. The system of claim 15, further comprising an optical device placed on the prism to magnify the signal emitted by the prism.

18. A wearable display system comprising:
a display panel to display a signal; and
a waveguide to receive the signal from the display panel and propagate the signal therein, the waveguide comprising an end to receive the signal and a side, an angle formed between the end and the side allowing total reflection of the signal within the waveguide.

19. The wearable display system according to claim 18, further comprising a lens to magnify the signal propagated through the waveguide.

20. The wearable display system according to claim 19, wherein the angle formed between the end and the side is the same as an angle of total reflection of the signal inside the waveguide.

21. The wearable display system according to claim 20, further comprising:
a frame to mount the waveguide;
a frame arm extending from the frame;
a light source mounted on the frame arm to emit the light; and
a reflection unit to reflect the emitted light to the waveguide.

22. The wearable display system according to claim 20, wherein the display system displays a virtual image of an object to a user.

23. The wearable display system according to claim 22, wherein a diameter D of the lens is calculated according to:
$$D = 2 L e tan \frac{θ}{2} + E x$$
wherein Le is a distance between an eye of the user and the lens, θ/2 is half of a field of view (FOV_{θ}) of the display system, and Ex is a size of an exit pupil of the eye of the user.

24. The wearable display system according to claim 23, wherein the field of view is calculated according to:
$$F O {V}_{θ} = 2 {tan}^{- 1} \frac{Y i}{2 {L}^{′}}$$
wherein Yi is a size of the virtual image, and
L′ is a distance between the eye of the user and the virtual image.

25. The wearable display system according to claim 19, wherein:
$$θ > {θ}_{c} = {sin}^{- 1} \frac{1}{n ( w a v e g u i d e )}$$
wherein θ is an angle of incidence of the signal on the lens, θ_{c} is a critical angle of total reflection within the waveguide, and n(waveguide) is an index of refraction of the waveguide.

26. A binocular wearable display system comprising:
a plurality of display panels to display a signal; and
a waveguide to receive the signal from the display panels and propagate the signal therein, the waveguide comprising first and second ends to receive the signal and a side, an angle formed between the ends and the side allowing total reflection of the signal within the waveguide.

27. The wearable display system according to claim 26, wherein the signal is light, and the display system further comprises:
a frame to mount the waveguide;
a plurality of frame arms extending from the frame;
a plurality of light sources mounted on the frame arms to emit the light; and
a plurality of reflection units to reflect the emitted light to the waveguide.
